(19) United States
(12) Patent Application Publication
(10) Pub. No.: US 2025/0192201 A1
(43) Pub. Date: Jun. 12, 2025

(54) FUEL CELL SYSTEM COMPRISING A PLURALITY OF INERTIZABLE FUEL CELL STACKS, AS WELL AS A METHOD FOR OPERATING SUCH A FUEL CELL SYSTEM

(71) Applicant: Robert Bosch GmbH, Stuttgart (DE)

(72) Inventor: Jochen Braun, Heimsheim (DE)

(21) Appl. No.: 18/845,547

(22) PCT Filed: Feb. 21, 2023
(86) PCT No.: PCT/EP2023/054287

§ 371 Date: Sep. 10, 2024

(30) Foreign Application Priority Data
Mar. 11, 2022 (DE) 10 2022 202 456.7

(51) Int. Cl. H01M 8/04082; H01M 8/04119; H01M 8/249

(52) U.S. Cl. CPC H01M 8/04201; H01M 8/04156; H01M 8/249

(57) ABSTRACT

A fuel cell system comprises a first fuel cell stack having a first compressor, a first supply air inlet, and a first exhaust air outlet, at least one second fuel cell stack having a second compressor, a second supply air inlet, and a second exhaust air outlet, a central supply air connector having a supply air shutoff valve, a central exhaust connector having an exhaust air shutoff valve, and a control unit, wherein the first supply air inlet and the second supply air inlet are coupled to the central supply air connector, wherein the first exhaust air outlet and the second exhaust air outlet are coupled to the central exhaust connector, wherein the control unit is coupled to the first fuel cell stack, the at least one second fuel cell stack, the supply air shutoff valve, and the exhaust air shutoff valve, and wherein the control unit is designed to control the operation of the first fuel cell stack and the at least one second fuel cell stack such that the fuel cell stacks and a portion of the fuel cell system can transition to an inertization state, in which the supply air shutoff valve and the exhaust air shutoff valve are temporarily closed.

### BACKGROUND

The present invention relates to a fuel call system and a method for operating a fuel cell system.

In vehicles in which, among other things, drive energy is also supplied by fuel cells, the oxidizing agent (oxygen from the ambient air) is generally used to react with hydrogen to form water in the fuel cell and thus to supply electrical output by means of electrochemical conversion. Conventionally, ambient air is in this case supplied to one or multiple fuel cell stacks by means of a compressor. This requires an air mass flow and a corresponding pressure level depending on operating points. The compressor conventionally comprises a thermal flow machine. Optionally, energy recuperation from outflowing air can also be achieved by means of a turbine for air compression.

Concepts and methods are known for achieving an inertization of a single fuel cell stack, the cathode path of a fuel cell stack, or of its surrounding zones in order to improve degradation in particular.

### SUMMARY

One object of the invention is to propose a fuel cell system, which comprises a plurality of fuel cell stacks and facilitates inertization of the cathode path of the fuel cell stack.

Proposed is fuel cell system comprising a first fuel cell stack having a first compressor, a first supply air inlet and a first exhaust air outlet, at least one second fuel cell stack having a second compactor, a second supply air inlet and a second exhaust air outlet, a central supply air connector having an supply air shutoff valve, a central exhaust connector including an exhaust air shutoff valve, and a control unit, whereby the first supply air inlet and the second supply air inlet are coupled to the central supply air connector, whereby the first exhaust air outlet and the second exhaust air outlet are coupled to the central exhaust connector, whereby the control unit comprises the first fuel cell stack, which is coupled to at least one second fuel cell stack, the supply air shutoff valve and the exhaust air shutoff valve, and whereby the control unit is designed to control operation of the first fuel cell stack and the at least one second fuel cell stack such that the fuel cell stack and a portion of the fuel cell system can be transitioned to an inertization state in which the supply air shutoff valve and the exhaust air shutoff valve are temporarily closed, the first compressor does not convey incoming air into the first supply air inlet, and the at least one second compressor is in operation such that exhaust air from the at least one second fuel cell stack enters first exhaust air outlet and recirculates through the first fuel cell stack into the at least one second supply air inlet.

Using a fuel cell system designed in this manner in particular, harmful starts with oxygen diffused onto the anode side due to prolonged downtime can be avoided. Also, a state can be avoided in which acidic material reaches the cathode side and hydrogen reaches the anode side without an electrical flow of current. The service life of the fuel cell system can thus be significantly increased. In addition to improving stack degradation, this concept can also be used to optimize the operational strategy and improve system behavior, particularly in operating modes outside of normal operation such as start-stop, shutting down the system, bleed-down, standby, freeze-start, regeneration operation, standstill phases with wake-up, etc.

The fuel cell stacks can in particular comprise fuel cells having a polymer electrolyte membrane. They comprise a plurality of fuel cells, which are present in a stacked arrangement and in particular comprise an electrical series and/or parallel connection for increasing the output voltage and/or the specified current. The fuel cells are preferably separated from each other by bipolar plates, which distribute the educts over a large area, take up and discharge product water, implement active cooling, and allow the flow of current. Each fuel cell stack comprises an anode path and a cathode path, whereby the supply air inlets are supplied with air, and exhaust air is delivered to the exhaust air outlets. Hydrogen is supplied to the anode paths. For this purpose, corresponding lines, valves, and other devices are provided that adjust and maintain a pressure level dependent on the operating point of the respective fuel cell stack. Such an arrangement is also referred to as “a balance of plant”. However, this is insignificant in the context of the present invention.

The first compressor and/or the second compressor can be single-staged or multi-staged, depending on the design of the individual fuel cell stacks and the maximum power required at a time. It is particularly advantageous to use an electrically operable compressor which is supplied with an adjusted electric voltage by, e.g., an inverter, and is easy to control using the control unit. The respective compressor could be coupled to a single compressor impeller or two compressor impellers, whereby the latter are pneumatically parallel or connected in series to one another. The compressors are used to compress fresh air from the surrounding environment to a desired pressure level and to supply it to the respective fuel cell stacks.

The compressors receive fresh air exclusively via the central supply air connector. All exhaust air outlets of the fuel cell stacks are connected to the central exhaust connector. If the supply air connector is closed by closing the supply air shutoff valve and the central exhaust connector is closed by closing the exhaust air shutoff valve, then a completely closed volume is created in the air lines and cathode paths of the fuel cell stacks. If oxygen is present in this closed volume, then it can be degraded by the fuel cell reaction by the drawing of power-thus achieving inertization. A special operational strategy of the fuel cell system is provided for this purpose, which is in this context referred to as an inertization method, at the end of which an interization state is achieved. In this case, the first compressor is, e.g., switched off. The at least one second compressor is operated further so that air already present in the system is actively directed into the at least one second fuel cell stack. However, since supply from outside is not possible, the existing oxygen is progressively degraded, while the first fuel cell stack and the associated media lines are used in this operating state exclusively to recirculate the exhaust air from the at least one second exhaust air outlet to the at least one second supply air inlet. This is true because the oxygen can only be degraded in one or even in a plurality of fuel cell stacks. If power is drawn in all stacks, then the inertization will go faster. No OCV (Open Circuit Voltage) is present due to drawing current in all stacks. Preferably, all stacks involved in the recirculation circuit are involved in the degradation of oxygen in order to avoid excessive cell stresses.

The at least one second fuel cell stack could comprise a plurality of second fuel cell stacks. These can be operated simultaneously to inertize the overall system. The second compressors could be operated as normal. It is possible that the second fuel cell stacks will be operated at a low power level. The electrical power provided must be withdrawn to produce the inertization state, for example by storing it in an electric storage device or by consuming it by means of an electrical resistor or similar device that converts the electrical power into heat.

Upstream of the central exhaust connector, a media merging unit could be arranged in which fluid flows of the exhaust air outlets are merged. The media merging unit could comprise a receiving volume for receiving incoming moist exhaust air, as well as a corresponding outlet for dissipating exhaust air to the outside. It is conceivable that water separation could be performed in the media merging unit. In addition, it is possible that a sensor for sensing hydrogen could be provided in the media merging unit, which sensor can be coupled to the control unit in order to be able to diagnose the media flows with regard to their H2 content.

The media merging unit could also comprise a water tank designed to collect product water from the fuel cell stacks. The water collected could, e.g., be used for other purposes in a fuel cell vehicle or other unit comprising the fuel cell system. The water could be removed from the water tank by a corresponding pump and fed to other arrangements. It is also conceivable that a portion of the captured water could be used to humidify supply air.

The first fuel cell stack could comprise a first turbine downstream of the first exhaust air outlet, whereby a selectively openable first turbine bypass could be arranged parallel to the first turbine, and whereby the control unit could be designed to open the first turbine bypass in the inertization process. The first turbine could be connected to the first compressor. Preferably, the turbine supports an electrical drive of the first compressor. The first turbine bypass can at least partially bypass the first turbine. If the fuel cell system is in the inertization process, then it may be useful to open the first turbine bypass. A simplified flow through the cathode path of the first fuel cell stack can then be facilitated in an inverted direction.

It is understood that the at least one second fuel cell stack also comprises a turbine, which can then be referred to as the second turbine. The latter can then assist the second compressor in question. Furthermore, the at least one second turbine could also comprise a second turbine bypass.

Each fuel cell stack could comprise an individual supply air shutoff valve and an individual exhaust air shutoff valve, whereby the control unit could be designed to separate at least one of the fuel cell stacks from the other fuel cell stacks after inertization by closing the relevant supply air shutoff valve and the relevant exhaust air shutoff valve in an inert state. For example, the supply air shutoff valve could be located directly upstream of the compressor in question. The exhaust air shutoff valve could be located directly downstream of the exhaust air outlet or a corresponding turbine. A fuel cell stack can thus be isolated from the remaining portion of the fuel cell system. If all of the fuel cell stacks are inertized, then at least one of these fuel cell stacks could be isolated specifically so that it remains in the inert state. An extended period of time up to a restart of the fuel cell stack in question could also be bridged in this state.

In one embodiment, no individual supply air shutoff valves could be arranged between the central supply air connector and the supply air inlets. The individual fuel cell stacks can thus be simplified so that the cost of manufacturing the fuel cell system can be reduced.

The invention further relates to a method for operating a fuel cell system comprising a plurality of fuel cell stacks for producing an inertization state, said method comprising closing a central supply air shutoff valve and a central exhaust air shutoff valve such that no fresh supply air can flow into the fuel cell system and no exhaust air can flow out of the fuel cell system, interrupting operation of a first compressor coupled to a first fuel cell stack, and operating at least one second compressor coupled to at least one second fuel cell stack such that exhaust air from the at least one second fuel cell stack enters a first exhaust air outlet of the first fuel cell stack and recirculates through the first fuel cell stack to at least one second supply air inlet.

### BRIEF DESCRIPTION OF THE DRAWINGS

Further measures for improving the invention are described in greater detail hereinafter, together with the description of the preferred exemplary embodiments of the invention, with reference to the drawings.

Shown are:

FIG. 1 a first exemplary embodiment of a fuel cell system,

FIG. 2 a second exemplary embodiment of a fuel cell system.

### DETAILED DESCRIPTION

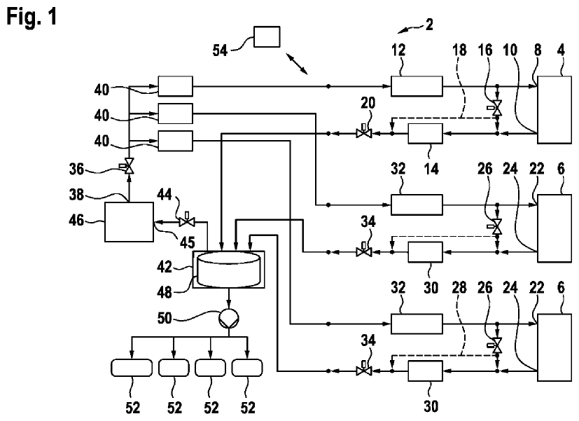

FIG. 1 shows a fuel cell system 2 in a schematic, block-based diagram. A first fuel cell stack 4 and two second fuel cell stacks 6 are provided in this case. The first fuel cell stack 4 comprises a first supply air inlet 8 and a first exhaust air outlet 10. A first compressor 12 is provided to provide supply air at a particular pressure at the supply air inlet 8. Exhaust air flows from the exhaust air outlet 10 into a first turbine 14, which is mechanically coupled to the first compressor 12 such that mechanical power is recovered from the exhaust air to assist in propelling the compressor 12. A first cathode bypass 16 is arranged between the first supply air inlet 8 and the first exhaust air outlet 10, through which a portion of the supply air can be directed past the first fuel cell stack 4. Likewise, a first turbine bypass 18 is provided, through which the first turbine 14 can be at least partially bypassed. A first exhaust air shutoff valve 20 can prevent exhaust air from flowing out and can optionally also be employed as a control valve for pressure regulation in the cathode path.

The second fuel cell stacks 6 are designed in a similar manner. They each comprise a second supply air inlet 22 and a second exhaust air outlet 24. A second cathode bypass 26 and a second turbine bypass 28 are provided. A second turbine 30 could be connected to a second compressor 32. A second exhaust air shutoff valve 34 is provided to selectively prevent exhaust air leakage.

One particularity is that a central supply air shutoff valve 36 is provided, which is coupled to a central supply air connector 38. A plurality of air filters 40 are connected downstream, each associated with one of the fuel cell stacks 4 and 6. These can also be realized as a single air filter that can be arranged upstream or downstream of the central supply air shutoff valve 36. All exhaust air outlets 10 and 24 are coupled to a media merging unit 42 connected to a central exhaust air shutoff valve 44. When open, exhaust air can flow into a surrounding environment 46 via a central exhaust air connector 45. By way of example, the media merging unit 42 comprises a water tank 48, in which product water is collected from the exhaust streams. A water pump 50 connected to the water tank 48 can be provided in order to supply water to a plurality of consumers 52. The consumers 52 can also be arranged within fuel cell system 2 and comprise, for example, supply air humidifiers (not shown).

A control unit 54 is coupled to the components specified. To inertize the fuel cell system 2, the central supply air shutoff valve 36 and the central exhaust air shutoff valve 44 can be closed. The second compressors 32 can continue to be operated to supply supply air to the second fuel cell stack 6. The first compressor 12 could be turned off such that exhaust air flowing from the second fuel cell stack 6 via the media merging unit 42 enters the first exhaust air outlet 10 to recirculate via the first supply air inlet 8 into the second supply air inlets 22. In such an inertization process, the oxygen is therefore degraded in the fuel cell stack located in the recirculation cycle.

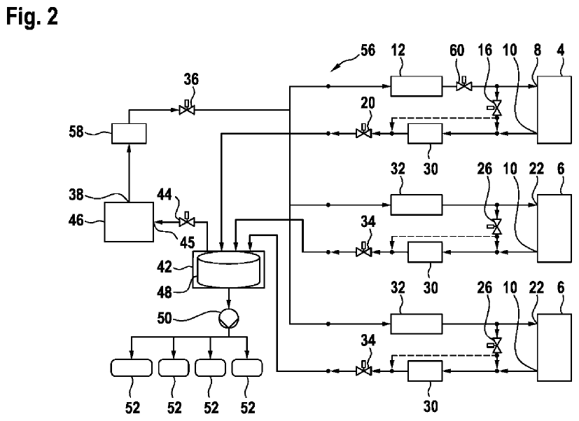

FIG. 2 shows a modification in the form of a fuel cell system 56, whereby a single air filter 58 is provided upstream of the central supply air shutoff valve 36 instead of the plurality of air filters 40. The individual fuel cell stacks 4 and 6 each comprise an individual supply air shutoff valve 60. In combination with the individual exhaust air shutoff valves 20 and 34 specified hereinabove, individual ones of the fuel cell stacks 4 and 6 can be separated from the rest of the system 56 so as to ensure they can be operational quickly, even for an extended period of time in an inertized state.

1. A fuel cell system (2, 56) comprising:
a first fuel cell stack (4) having a first compressor (12), a first supply air inlet (8), and a first exhaust air outlet (10),
at least one second fuel cell stack (6) having a second compressor (32), a second supply air inlet (22), and a second exhaust air outlet (24),
a central supply air connector (38) having a central supply air shutoff valve (36),
a central exhaust connector (45) having a central exhaust air shutoff valve (44), and
a control unit (54),
wherein the first supply air inlet (8) and the second supply air inlet (22) are coupled to the central supply air connector (38),
wherein the first exhaust air outlet (10) and the second exhaust air outlet (24) are coupled to the central exhaust connector (45),
wherein the control unit (54) is coupled to the first fuel cell stack (4), the at least one second fuel cell stack (6), the compressors (12, 32), the central supply air shutoff valve (36), and the central exhaust air shutoff valve (44), and
wherein the control unit (54) is configured to control the operation of the first fuel cell stack (4) and the at least one second fuel cell stack (6) such that at least the fuel cell stacks (4, 6) are transitionable, and from a non-inert state to an inertization state, in which the central supply air shutoff valve (36) and the central exhaust air shutoff valve (44) are temporarily closed, either the first compressor (12) or the at least one second compressor (32) does not convey incoming air into the first supply air inlet (8) or the second supply air inlet (22), and the at least one second compressor (32) or the first compressor (12) is in operation such that exhaust air from the at least one second fuel cell stack (6) or the first fuel cell stack (4) enters the first exhaust air outlet (10) or the second exhaust air outlet (24) and recirculates through the first fuel cell stack (4) or the second fuel cell stack (6) into the at least one second supply air inlet (22) or the first supply air inlet (8).

2. The fuel cell system (2, 56) according to claim 1,
wherein the at least one second fuel cell stack (6) comprises a plurality of second fuel cell stacks.

3. The fuel cell system (2, 56) according to claim 1,
wherein a media merging unit (42) is arranged upstream of the central exhaust connector (45), in which unit fluid flows from the exhaust air outlets (10, 24) are merged.

4. The fuel cell system (2, 56) according to claim 3,
wherein the media merging unit (42) comprises a water separator, and/or a water separation device, and/or a water tank (48) configured to collect product water from the fuel cell stacks (4, 6).

5. The fuel cell system (2, 56) according to claim 1,
wherein the first fuel cell stack (4) comprises a first turbine (14) downstream of the first exhaust air outlet (10),
wherein a selectively openable first turbine bypass (18) is arranged parallel to the first turbine (14), and
wherein the control unit (54) is configured to open the first turbine bypass (18) in the inertization state.

6. The fuel cell system (2, 56) according to claim 1,
wherein each fuel cell stack (4, 6) comprises an individual supply air shutoff valve (60) and an individual exhaust air shutoff valve (20, 34), and
wherein the control unit (54) is configured to separate at least one of the fuel cell stacks (4, 6) from the other fuel cell stacks (4, 6) in an inertized state after inertization by closing the relevant supply air shutoff valve (60) and the relevant exhaust air shutoff valve (20, 34).

7. The fuel cell system (2, 56) according to claim 1,
wherein no individual supply air shutoff valves (60) are arranged between the central supply air connector (38) and the supply air inlets (8, 22).

8. The fuel cell system (2, 56) according to claim 1,
wherein the fuel cell system (2, 56) is configured to draw an electrical current from at least one of the fuel cell stacks (4, 6), through which exhaust air is recirculated for inertization.

9. A method for operating a fuel cell system (2, 56) comprising a plurality of fuel cell stacks (4, 6) for producing an inertization state, said method comprising:
closing a central supply air shutoff valve (36) and a central exhaust air shutoff valve (44) such that no fresh supply air can flow into the fuel cell system (2, 56), and no exhaust air can flow out of the fuel cell system (2, 56),
controlling either a first compressor (12) or at least one second compressor (32) coupled to a first fuel cell stack (4) or at least one second fuel cell stack (6) such that no supply air is conveyed into a first supply air inlet (8) of the first fuel cell stack (4), or no supply air is conveyed into at least a second supply air inlet (22), and
operating the at least one second compressor (32) or the first compressor (12) such that exhaust air from the at least one second fuel cell stack (6) or the first fuel cell stack (4) enters a first exhaust air outlet (10) or a second exhaust air outlet (24) of the first fuel cell stack (4) or the at least one second fuel stack (6) and recirculates through the first fuel cell stack (4) or the at least one second fuel cell stack (6) into the at least one second supply air inlet (22) or the first supply air inlet (8).

10. The method according to claim 9,
wherein an electrical current is drawn from at least one of the fuel cell stacks (4, 6), through which exhaust air is recirculated for inertization.
